(19) United States
(12) Patent Application Publication
(10) Pub. No.: US 2025/0067474 A1
(43) Pub. Date: Feb. 27, 2025

(54) Systems and Methods for Detecting Pressure in a Gas Furnace

(71) Applicant: Rheem Manufacturing Company, Atlanta, GA (US)

(72) Inventors: Michael John Knieser, Fishers, IN (US); Mohammad Taha Ahmad, Fort Smith, AR (US); Robert A. Oglesbee, Fishers, IN (US); Shawn Allan Reed, Charleston, AR (US); Darryl Farley, Fayetteville, AR (US)

(21) Appl. No.: 18/799,885

(22) Filed: Aug. 9, 2024

Related U.S. Application Data
(60) Provisional application No. 63/534,008, filed on Aug. 22, 2023.

(51) Int. Cl. F24H 15/104; F23L 17/00; F23N 1/02; F24H 3/02; G01L 19/08

(52) U.S. Cl. CPC F24H 15/104; F23L 17/005; F23N 1/022; F24H 3/025; G01L 19/086; F23N 2225/06; F23N 2235/16; F23N 2237/10

(57) ABSTRACT

Systems and methods are provided for gas furnace systems, including a pressure transducer and optionally one or more pressure switches for efficiently achieving multiple operating modes and/or multiple fuel-to-air mixtures. The pressure transducer may determine a pressure setting at the heat exchanger and based on the pressure value may determine an amount to open a gas valve. As pressure transducer is capable of detecting a range of pressures, multiple different operational modes may be achieved by adjusting the opening of the gas valve depending on the detected pressure. The pressure switches may be used to calibrate and/or confirm the accuracy of the pressure transducer. For example, the output of a pressure switch may be compared to an output of a pressure transducer at a given inductor fan setting to determine whether the pressure transducer is accurate and/or calibrated.

### CROSS-REFERENCE TO RELATED APPLICATION

This application claims the benefit of U.S. Application No. 63/534,008, filed Aug. 22, 2023, the entirety of which is incorporated herein by reference.

### TECHNICAL FIELD

The present disclosure is generally in the field of gas furnaces. For example, systems and methods are provided herein for gas furnaces including a gas furnace with a pressure transducer and/or a pressure switch.

### BACKGROUND

Gas furnace systems have been developed to heat the interior of structures such as residential and commercial structures. Gas furnace systems typically burn a combustible fluid such as natural gas to generate heat that may then be distributed throughout an interior of a structure. For example, FIG. 1 illustrates an exemplary gas furnace system, furnace 100, which may include heat exchanger 106 which may include an ignitor connected to a gas valve which may be actuated by controller 110. Inductor fan 102 may generate airflow through the heat exchanger and the igniter. Blower 114 may generate airflow over the heat exchanger for distribution of heated air.

Pressure switch 104 may activate electrical switch 112 when a certain air pressure is achieved at heat exchanger 106. Once electrical switch 112 is activated, the gas valve may be actuated (e.g., by controller 110) to permit gas flow to the ignitor for combustion at a desired air-to-gas ratio. The pressure switch may be designed such that a minimum operational pressure for ignition at the heat exchanger is the same pressure that causes electrical switch 112 to activate. In this manner, pressure switch 104 may prevent operation of the pump if the minimum operational pressure is not achieved.

While gas furnace 100 with pressure switch 104 may prevent the heat exchanger from operating below a minimum air pressure, such a system illustrated in FIG. 1 only offers a single operational mode. Multiple pressure switches may be included and used to safely operate a gas furnace at multiple air pressures and thus multiple air-to-gas ratios, resulting in multi-mode operation. However, the number of modes would be limited by the number of pressure switches included in furnace 100 and each pressure switch increases the cost, maintenance, and complexity of the system.

Accordingly, there is a need for improved methods and systems for safely and cost effectively operating a gas furnace at multiple operating modes having various fuel-to-air ratios or mixtures.

### BRIEF DESCRIPTION OF THE DRAWINGS

FIG. 1 is a schematic illustration of a gas furnace system with a pressure switch.

FIG. 2 is a schematic illustration of a gas furnace system with a pressure transducer facilitating multiple operation modes, in accordance with one or more example embodiments of the disclosure.

FIG. 3 is a schematic illustration of a gas furnace system with a pressure transducer and pressure switches facilitating multiple operation modes, in accordance with one or more example embodiments of the disclosure.

FIGS. 4A-4C are schematic illustrations of wired and wireless connections between a pressure transducer and pressure switches and a controller and a parallel arrangement of a pressure transducer and a pressure switch, in accordance with one or more example embodiments of the disclosure.

FIG. 5 is a schematic illustration of an example process flow for checking accuracy of pressure transducer using pressure switches, in accordance with one or more example embodiments of the disclosure.

FIG. 6 is a schematic block diagram of a gas furnace system in accordance with one or more example embodiments of the disclosure.

### DETAILED DESCRIPTION

Furnace systems have been developed for heating residential and commercial structures using a combustible fluid (e.g., natural gas) and capable of efficiently achieving multiple operating modes and/or multiple fuel-to-air mixtures. For example, a gas furnace system may include a heat exchanger and an induction fan for causing airflow through the heat exchanger. The induction fan and/or heat exchanger may include a pressure transducer and optionally one or more pressure switches.

The pressure switches may be used to calibrate and/or confirm the accuracy of the pressure transducer. The pressure transducer may be in communication with a controller controlling a valve connecting to a gas line for adjusting gas flow into the ignition of the heat exchanger based on a pressure detected by the pressure transducer. As the pressure transducer is designed to detect a wide range or spectrum of pressures and the valve is designed to be incrementally opened or closed varying degrees, the pressure transducer together with the gas valve may achieve multiple different operational modes and/or fuel-to-air mixtures or ratios.

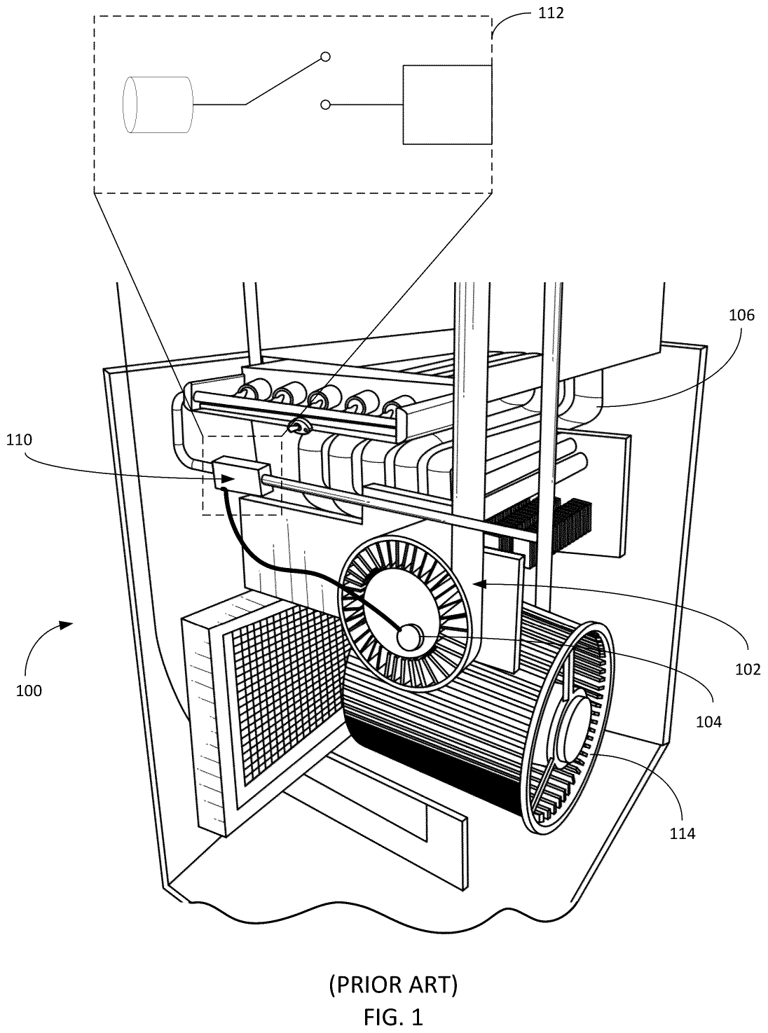

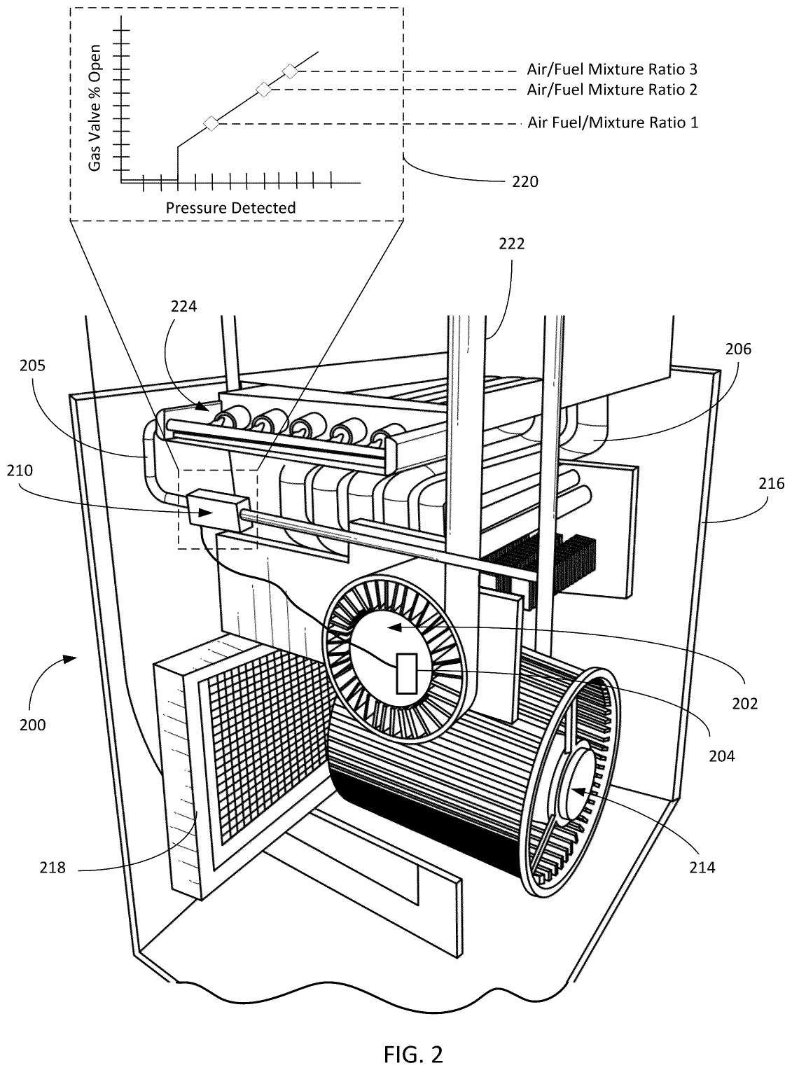

Referring now to FIG. 2, a schematic illustration of a gas furnace system including a pressure transducer is illustrated in accordance with one or more example embodiments of the disclosure. Specifically, gas furnace 200 may be designed to have a variety of operating modes and/or may achieve a variety of fuel-to-air mixtures (e.g., ratios). As shown in FIG. 1, gas furnace 100 may only include pressure transducer 104 and may not include any other pressure switches, pressure sensors, or the like.

As shown in FIG. 2, gas furnace system 200, may include heat exchanger 206, ignition 224, controller 210, inductor fan 202, pressure transducer 204, blower 214, inlet 218, exhaust 222 and/or housing 216. It is understood that gas furnace system 200 may include greater or fewer components than those illustrated in FIG. 2 and/or that one or more components in FIG. 2 may be optional.

Controller 210 may be any computing device with a processor and may include one or more displays (e.g., touch screen display), one or more user interfaces (e.g., buttons), and/or one or more speakers and/or microphones. Controller 210 may communicate with one or more or other computing devices (e.g., remote controllers, smart phones, tablets, servers, etc.) via any suitable wired or wireless system (e.g., Wi-Fi, cellular network, Bluetooth, Bluetooth Low Energy (BLE) network, near field communication protocol, or the like).

Pressure transducer 204 may be any suitable pressure transducer designed to translate a mechanical displacement due to a pressure force into an electrical signal, the electrical signal indicative of a detected pressure. As pressure varies so too may the electrical signal, such that pressure changes may be continuously detected. Pressure transducer 204 may communicate with controller 210 via any suitable wired or wireless system.

Controller 210 may also be in communication with (e.g., via any suitable wired or wireless system) and/or may otherwise control an adjustable gas valve, which may control gas flow from gas line 205 into ignition 224. The gas valve may be any suitable gas valve which may be actuated to open or close a certain degree or percentage such that the flow of gas may be adjusted between 0 and 100% open. The gas valve may be situated in controller 210, ignition 224, and/or along gas line 205, for example.

Ignition 224 may be any suitable ignition which may cause combustion of gas received from gas line 205. Heat exchanger 206 may receive hot exhaust from ignition 224 and may direct the exhaust through a plurality of tubing terminating at inductor fan 202. Inductor fan 202 may be any suitable blower or other fan for generating an airflow within the tubing of heat exchanger 206, such that air flows across ignition 224, causing hot exhaust from heat exchanger 224 to be directed into tubing 206.

A fuel-to-air ratio at ignition 224 may be adjusted based on the degree at which the gas valve is opened and/or the airflow at ignition 224, generated by inductor fan 202. To determine the pressure at ignition 224 and thus the airflow, pressure transducer 204 may be positioned in or near inductor fan 204. While pressure transducer 204 is illustrated incorporated into inductor fan 202 in FIG. 2, pressure transducer may be positioned elsewhere within housing 216. The hot exhaust may be discharged from gas furnace 200 via exhaust 222.

As heated air travels through heat exchanger 206, blower 214 may generate a flow across heat exchanger 206. Blower 214 may be any suitable blower or fan. For example, air may enter inlet 218, be directed through blower 214, and across heat exchanger 206, and ultimately exit housing 206 to enter ducting of the residential or commercial structure. By adjusting the gas valve permitting gas to enter ignition 224, the heat generated by heat exchanger 206 may be adjusted, resulting in different heat modes. A user may select a desired heat mode based on the heating needs for the residential or commercial structure.

Pressure transducer 204 may detect a range of pressures, which may be indicative or representative of a pressure and/or airflow at ignition 224. A minimum pressure corresponding to a minimum airflow at ignition 224 may be required to safely ignite gas supplied from gas line 205. Pressure transducer 204 may, for example, detect pressures from or near the minimum operational pressure and pressures between the minimum operational pressure or airflow at ignition 224 and a maximum operational pressure and/or airflow. For example, operational pressure for the gas furnace system may be between 0 and 5 inches of water, with a minimum operational pressure of 0.01 inches of water and a maximum operational pressure of 5 inches of water.

Pressure transducer 204 may send an electrical signal indicative of the pressure sensed at pressure transducer 204 and/or a wireless message indicative of the same to controller 210. Based on the pressure determined from the electrical and/or wireless signal or message, controller 210 may determine an amount to open the gas valve. For example, controller 210 may maintain a table, database, plot, data, or other information associating certain pressures with an amount or degree for opening the gas valve.

In one example, controller 210 may maintain a set of data points associating degrees of valve opening with detected pressures. For example, plot 220 may illustrate the amount the gas valve will be opened in response to pressures detected. As shown in plot 220, the gas valve may remain closed until a certain minimum pressure is detected. Once a minimum pressure is achieved the gas valve may be continuously opened as detected pressure increases. While plot 220 depicts a linear curve, it is understood that any plot shape may be achieved and/or desirable.

As shown in plot 220, each point along the plot representing a certain degree or percent valve open and pressure detected may also correspond to a fuel-to-air mixture ratio. Fuel-to-air mixture ratios may be calculated and/or determined for each point along the plot. For example, there may be certain points along the plot (e.g., certain pressure, valve setting combinations) for which the fuel-to-air ratio (e.g., air/fuel mixture 1, 2, or 3) is known to be optimal or otherwise desirable (e.g., generates least amount of undesirable byproducts) and therefore may be selected by the controller 210.

In one example, controller 210 may optionally also control inductor fan 202 and may generate an airflow using inductor fan 202 determined to generate a certain pressure corresponding to a desired fuel-to-air mixture. Once the identified pressure is detected using pressure transducer 204, controller 210 may adjust the gas valve to the prescribed percent or degree open, as set forth in plot 220, to achieve the desire fuel-to-air mixture. As pressure transducer 204 is not limited to only one pressure detection amount, the gas furnace system is capable of operating at various modes along plot 220.

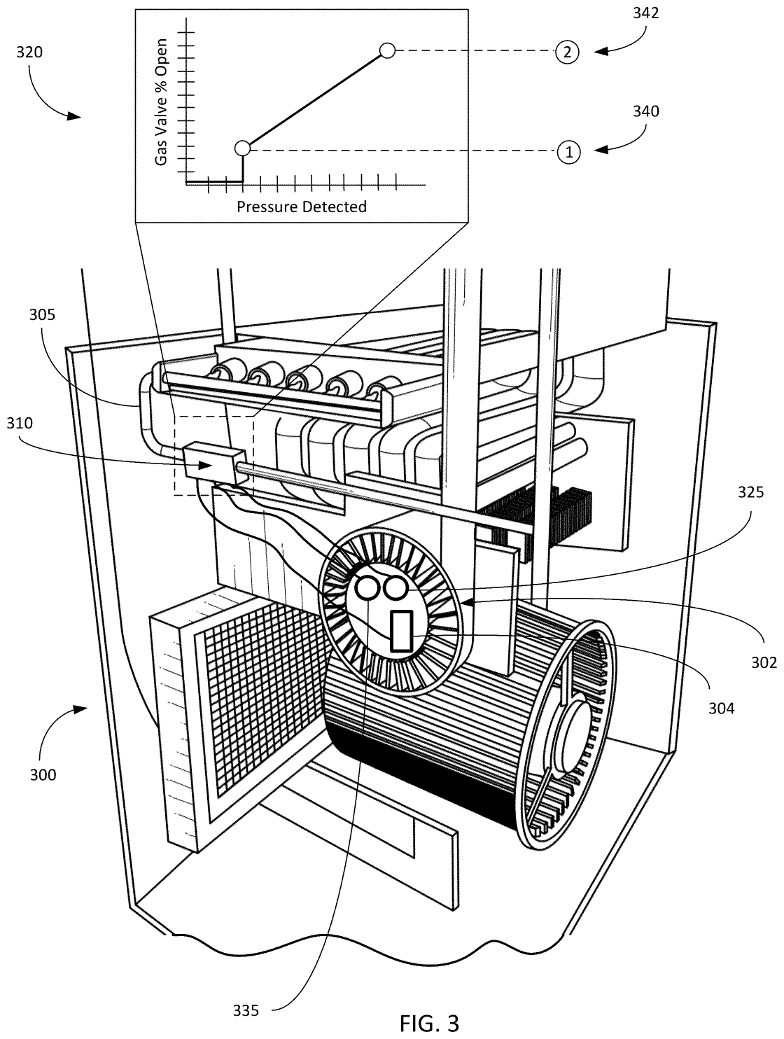

Referring now to FIG. 3, a schematic illustration of a gas furnace system including a pressure transducer and pressure switches is illustrated in accordance with one or more example embodiments of the disclosure. Specifically, gas furnace 300 may be designed to have a variety of operating modes and/or may achieve a variety of fuel-to-air mixtures and may confirm accuracy of the pressure transducer. While gas furnace 300 includes two pressure switches, it is understood that only one pressure switch may be included.

Gas furnace 300 may be similar to gas furnace 200 of FIG. 2, but may additionally include pressure switch 325 and/or pressure switch 335. Pressure switch 325 and/or pressure switch 335 may be any suitable pressure switch which may maintain an electrical switch in an open position until a certain ambient pressure actuates pressure switch 325 and/or pressure switch 335 and causes the respective electric switch to close, thereby generating an electrical signal.

Gas furnace 300 may include the same components of gas furnace 200, with the exception of pressure switch 325 and/or pressure switch 335. Pressure switch 325 and pressure switch 335 may be the same but pressure switch 325 may be set to actuate to close the electrical circuit at a pressure that may be lower than pressure switch 335. The gas valve that restricts flow of gas line 305 may communicate with controller 310 to actuate to restrict gas flow based on the pressure detected by pressure transducer 304.

Pressure switches 325 and/or 335 may be used to confirm the accuracy of pressure transducer 304. For example, as shown in plot 320, controller 310 may maintain data and/or a plot associating certain percent or degree open of the gas valve to the pressure detected by pressure transducer 304. A minimum operating pressure may be set at pressure value 340. A maximum operating pressure may be set at a maximum pressure value 342. In one example, pressure switch 325 may correspond to pressure value 340, which may correspond to a certain air-to-fuel mixture value, and pressure switch 335 may correspond to pressure value 342, which may correspond to a different air-to-fuel mixture value.

In one example, pressure switch 325 may be set to actuate or otherwise generate an electrical signal at first pressure value 340 and/or pressure switch 335 may be set to actuate or otherwise generate an electrical signal at pressure value 342. It is understood that controller 310 may only include one pressure switch or more than two pressure switches. It is further understood that the pressure switches may be associated or set at different pressure values than those illustrated in FIG. 3.

To confirm the accuracy of pressure transducer 304, controller 310 may cause inductor fan 302 to operate at a first setting estimated or known to generate a first pressure or alternatively to incrementally increase in speed. When the pressure transducer achieves the known or estimated pressure, which may be the operating pressure, controller 310 may determine whether pressure switch 325, which may be designed to activate at the known or estimated pressure, is activated (e.g., with the electrical switch closed or activated). If the pressure switch is activated, then the pressure transducer may be deemed to be accurate. If it is not activated, then the pressure transducer may be faulty or not calibrated.

Gas furnace 300 may similarly cause inductor fan 302 to increase speed to generate an airflow resulting in a pressure at which pressure switch 335 is designed to activate (e.g., maximum operational temperature). When the pressure transducer achieves the known or estimated pressure, which may be the operating pressure, controller 310 may determine whether pressure switch 335 is activated (e.g., with the electrical switch closed or activated). If the pressure switch is activated, then the pressure transducer may be deemed to be accurate. If it is not activated, then the pressure transducer may be faulty or not calibrated.

Controller 310 may be designed to check the accuracy of pressure transducer 304 when gas furnace 300 is not operating (e.g., during down time). For example, a gas furnace may quickly achieve minimum and maximum operational pressures at set periods of time (e.g., every hour, every week, every month). In another example, only one pressure switch may be included and may be designed to activate at a pressure between minimum and maximum operational pressures.

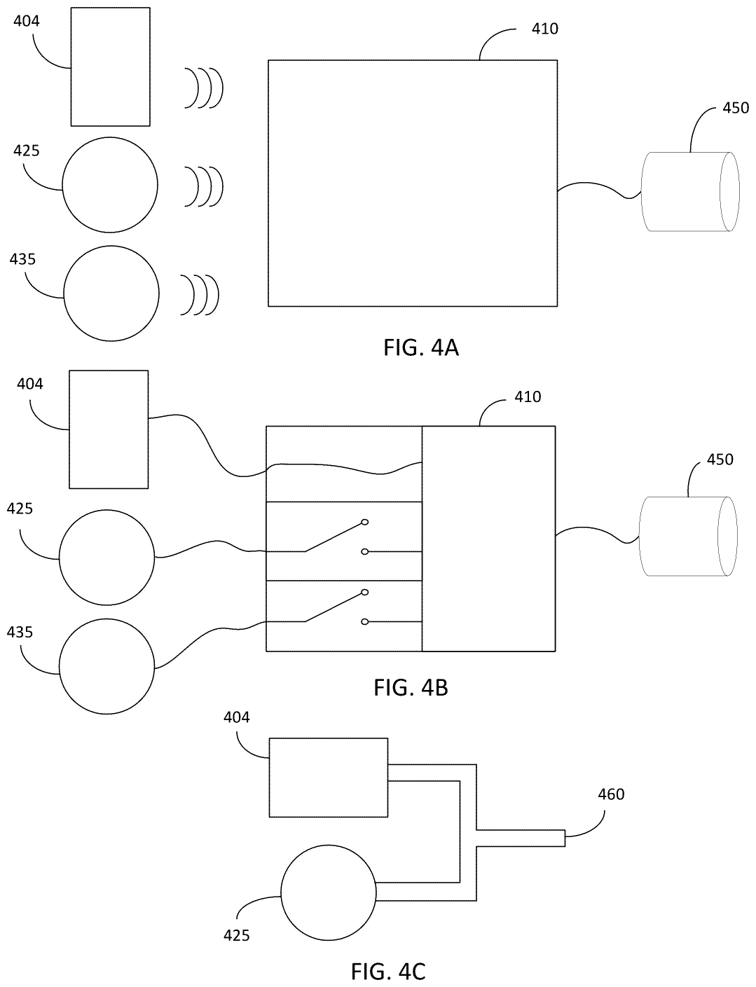

Referring now to FIGS. 4A-4C, schematic illustrations of wired and wireless connections between a pressure transducer and pressure switches and a controller and a parallel arrangement of a pressure transducer and a pressure switch are depicted, in accordance with one or more example embodiments of the disclosure. Specifically, in FIG. 4A, pressure transducer 404, pressure switch 425, and/or pressure switch 435 may be in wireless communication with controller 410, which may actuate gas valve 450 to open or close gas valve 450 by a certain amount.

Pressure transducer 404, pressure switch 425, pressure switch 435, and/or controller 410, may be the same as or similar to pressure transducer 304, pressure switch 325, pressure switch 335, and/or controller 310 of FIG. 3. As shown in FIG. 4B, pressure transducer 404, pressure switch 425, and/or pressure switch 435 may be in wired communication with controller 410. Referring now to FIG. 4C, pressure transducer 404 and pressure transducer 425, and optionally pressure transducer 435 may be arranged in parallel such that an inlet of pressure transducer 404 and pressure transducer 425, and optionally pressure transducer 435, is in communication with a common inlet (e.g., inlet 460).

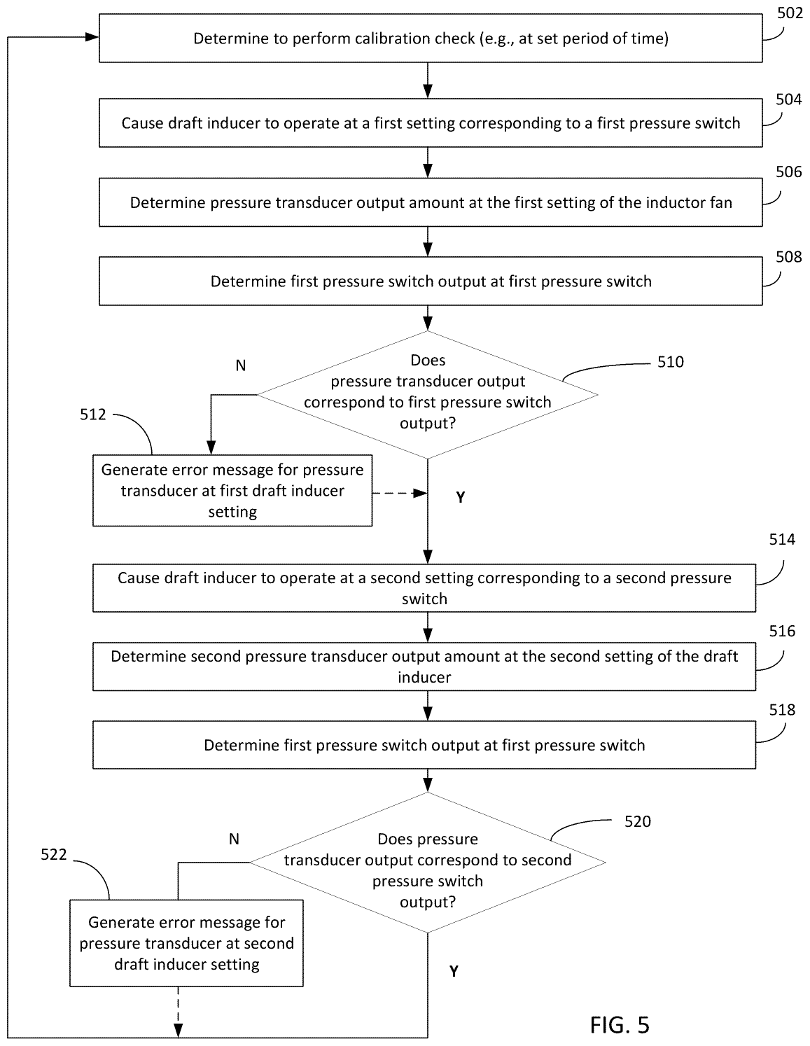

Referring now to FIG. 5, an example process flow for checking the accuracy of a pressure transducer of a gas furnace is depicted in accordance with one or more example embodiments of the disclosure. The operations and/or tasks set forth in the example process flow may be performed by a controller, which may be the same as or similar to controller 210. While example embodiments of the disclosure may be described in the context of a controller, it should be appreciated that the disclosure is more broadly applicable to various types of computing devices as well as a controller and/or server. Some or all of the blocks of the process flows in this disclosure may be performed in a distributed manner across any number of devices. The operations of the process flow may be optional and may be performed in a different order.

At block 502, computer-executable instructions stored on a memory of a device, such as a controller, may be executed to determine to perform the calibration check (e.g., at a set time or elapsed time). At block 504, computer-executable instructions stored on a memory of a device, such as a controller, may be executed to cause the draft inducer to operate at a first setting which may, for example, correspond to a first pressure switch. At block 506, computer-executable instructions stored on a memory of a device, such as a controller, may be executed to determine a pressure transducer output (e.g., signal) at the first setting of the inductor fan (e.g., draft inducer).

At block 508, computer-executable instructions stored on a memory of a device, such as a controller, may be executed to determine the output of the first pressure switch at the first setting of the inductor fan (e.g., this may be a signal to indicate that the electric switch has closed). At decision 510 computer-executable instructions stored on a memory of a device, such as a controller, may be executed to determine whether the pressure transducer output corresponds to the pressure switch output (e.g., whether they indicate the same pressure value).

If the outputs don't indicate the same pressure value, then at block 512, computer-executable instructions stored on a memory of a device, such as a controller, may be executed to generate an error message for the pressure transducer at the first inductor fan setting. Alternatively, if the outputs do indicate the same pressure value, then at block 514, computer-executable instructions stored on a memory of a device, such as a controller, may be executed to cause the inductor fan to operate at a second setting corresponding to a second pressure switch. Optionally, step 514 may also be initiated after block 512.

At block 516, computer-executable instructions stored on a memory of a device, such as a controller, may be executed to determine the pressure transducer output amount at the second setting of the inductor fan. At block 518, computer-executable instructions stored on a memory of a device, such as a controller, may be executed to determine the second pressure switch output amount at the second setting of the inductor fan.

At decision 520 computer-executable instructions stored on a memory of a device, such as a controller, may be executed to determine whether the pressure transducer output corresponds to the pressure switch output (e.g., whether they indicate the same pressure value). If the outputs don't indicate the same pressure value, then at block 522, computer-executable instructions stored on a memory of a device, such as a controller, may be executed to generate an error message for the pressure transducer at the second draft inducer setting. Alternatively, if the outputs do indicate the same pressure value, then the pressure transducer may be calibrated and/or accurate and the process and block 502 may be reinitiated. Block 502 may optionally be reinitiated after block 522 as well.

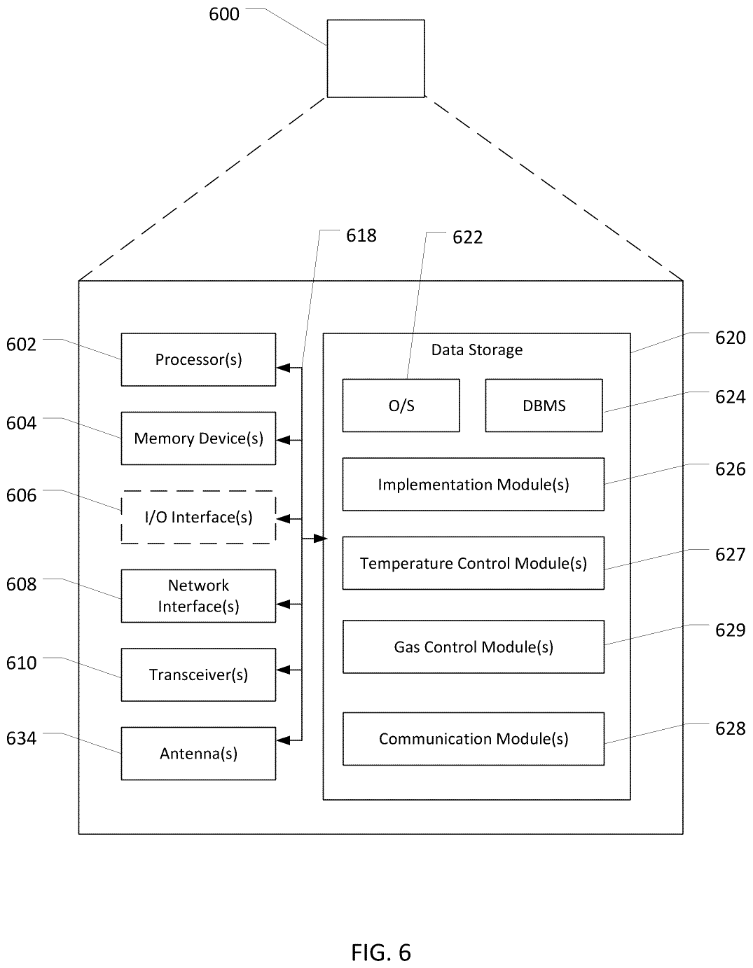

FIG. 6 is a schematic block diagram of an illustrative controller 600, which may be included in a gas furnace. Controller 600 may be the same as or similar to controller 210 of FIG. 2 or otherwise one or more of the controllers of FIGS. 3-5. It is understood that a controller of the gas furnace may alternatively, or additionally, include one or more of the components illustrated in FIG. 6 and a controller and/or server may alone or together perform one or more of the operations of controller 600.

Controller 600 may be designed to communicate with one or more gas valves, ignitors, gas valves, inductor fans, blower fans, pressure transducers, and/or pressure switches. Controller 600 may be designed to communicate via one or more networks. Such network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks.

In an illustrative configuration, controller 600 may include one or more processors 602, one or more memory devices 604 (also referred to herein as memory 604), one or more input/output (I/O) interface(s) 606, one or more network interface(s) 608, one or more transceiver(s) 610, one or more antenna(s) 634, and data storage 620. The controller 600 may further include one or more bus(es) 618 that functionally couple various components of the controller 600.

The bus(es) 618 may include at least one of a system bus, a memory bus, an address bus, or a message bus, and may permit exchange of information (e.g., data (including computer-executable code), signaling, etc.) between various components of the controller 600. The bus(es) 618 may include, without limitation, a memory bus or a memory controller, a peripheral bus, an accelerated graphics port, and so forth. The bus(es) 618 may be associated with any suitable bus architecture including.

The memory 604 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In various implementations, the memory 604 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth.

The data storage 620 may include removable storage and/or non-removable storage including, but not limited to, magnetic storage, optical disk storage, and/or tape storage. The data storage 620 may provide non-volatile storage of computer-executable instructions and other data. The memory 604 and the data storage 620, removable and/or non-removable, are examples of computer-readable storage media (CRSM) as that term is used herein. The data storage 620 may store computer-executable code, instructions, or the like that may be loadable into the memory 604 and executable by the processor(s) 602 to cause the processor(s) 602 to perform or initiate various operations. The data storage 620 may additionally store data that may be copied to memory 604 for use by the processor(s) 602 during the execution of the computer-executable instructions. Moreover, output data generated as a result of execution of the computer-executable instructions by the processor(s) 602 may be stored initially in memory 604, and may ultimately be copied to data storage 620 for non-volatile storage.

The data storage 620 may store one or more operating systems (O/S) 622; one or more optional database management systems (DBMS) 624; and one or more program module(s), applications, engines, computer-executable code, scripts, or the like such as, for example, one or more implementation modules 626, temperature control modules 627, gas control modules 629, and one or more communication modules 628. Some or all of these modules may be sub-modules. Any of the components depicted as being stored in data storage 620 may include any combination of software, firmware, and/or hardware. The software and/or firmware may include computer-executable code, instructions, or the like that may be loaded into the memory 604 for execution by one or more of the processor(s) 602. Any of the components depicted as being stored in data storage 620 may support functionality described in reference to correspondingly named components earlier in this disclosure.

Referring now to other illustrative components depicted as being stored in the data storage 620, the O/S 622 may be loaded from the data storage 620 into the memory 604 and may provide an interface between other application software executing on the controller 600 and hardware resources of the controller 600. More specifically, the O/S 622 may include a set of computer-executable instructions for managing hardware resources of the controller 600 and for providing common services to other application programs (e.g., managing memory allocation among various application programs). In certain example embodiments, the O/S 622 may control execution of the other program module(s) to for content rendering. The O/S 622 may include any operating system now known or which may be developed in the future including, but not limited to, any server operating system, any mainframe operating system, or any other proprietary or non-proprietary operating system.

The optional DBMS 624 may be loaded into the memory 604 and may support functionality for accessing, retrieving, storing, and/or manipulating data stored in the memory 604 and/or data stored in the data storage 620. The DBMS 624 may use any of a variety of database models (e.g., relational model, object model, etc.) and may support any of a variety of query languages. The DBMS 624 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like.

The optional I/O interface(s) 606 may facilitate the receipt of input information by the controller 600 from one or more I/O devices as well as the output of information from the controller 600 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; and so forth. Any of these components may be integrated into the controller 600 or may be separate.

The controller 600 may further include one or more network interface(s) 608 via which the controller 600 may communicate with any of a variety of other systems, platforms, networks, devices, and so forth. The network interface(s) 608 may enable communication, for example, with one or more wireless routers, one or more host servers, one or more web servers, and the like via one or more of networks.

The antenna(s) 634 may include any suitable type of antenna depending, for example, on the communications protocols used to transmit or receive signals via the antenna(s) 634. Non-limiting examples of suitable antennas may include directional antennas, non-directional antennas, dipole antennas, folded dipole antennas, patch antennas, multiple-input multiple-output (MIMO) antennas, or the like. The antenna(s) 634 may be communicatively coupled to one or more transceivers 612 or radio components to which or from which signals may be transmitted or received. Antenna(s) 634 may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals including BLE signals, a Near Field Communication (NFC) antenna for transmitting or receiving NFC signals, a 900 MHz antenna, and so forth.

The transceiver(s) 612 may include any suitable radio component(s) for, in cooperation with the antenna(s) 634, transmitting or receiving radio frequency (RF) signals in the bandwidth and/or channels corresponding to the communications protocols utilized by the controller 600 to communicate with other devices. The transceiver(s) 612 may include hardware, software, and/or firmware for modulating, transmitting, or receiving-potentially in cooperation with any of antenna(s) 634—communications signals according to any of the communications protocols discussed above including, but not limited to, one or more Wi-Fi and/or Wi-Fi direct protocols, as standardized by the IEEE 802.11 standards, one or more non-Wi-Fi protocols, or one or more cellular communications protocols or standards. The transceiver(s) 612 may further include hardware, firmware, or software for receiving GNSS signals. The transceiver(s) 612 may include any known receiver and baseband suitable for communicating via the communications protocols utilized by the controller 600. The transceiver(s) 612 may further include a low noise amplifier (LNA), additional signal amplifiers, an analog-to-digital (A/D) converter, one or more buffers, a digital baseband, or the like.

Referring now to functionality supported by the various program module(s) depicted in FIG. 6, the implementation module(s) 626 may include computer-executable instructions, code, or the like that responsive to execution by one or more of the processor(s) 602 may perform functions including, but not limited to, overseeing coordination and interaction between one or more modules and computer executable instructions in data storage 620, determining user selected actions and tasks, determining actions associated with user interactions, determining actions associated with user input, initiating commands locally or at remote devices, and the like.

The temperature control module(s) 627 may include computer-executable instructions, code, or the like that responsive to execution by one or more of the processor(s) 602 may perform functions including, but not limited to, receiving input such as user input or sensor input used to inform a temperature setting and/or operational setting and monitor operation of the gas furnace to achieve a certain temperature and/or operational setting.

The communication module(s) 628 may include computer-executable instructions, code, or the like that responsive to execution by one or more of the processor(s) 602 may perform functions including, but not limited to, communicating with one or more devices, for example, via wired or wireless communication, communicating with mobile devices, communicating with servers (e.g., remote servers), communicating with remote datastores and/or databases, sending or receiving notifications or commands/directives, communicating with cache memory data, communicating with user devices, and the like.

The gas control module(s) 629 may include computer-executable instructions, code, or the like that responsive to execution by one or more of the processor(s) 602 may perform functions including, but not limited to, operating the gas furnace to achieve a desired temperature and/or operational setting or mode. For example, pump operation module 629 may perform calibration checks on a pressure transducer and/or may adjust the gas valve.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Program module(s), applications, or the like disclosed herein may include one or more software components, including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines, and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a CRSM that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

That which is claimed is:

1. A furnace system comprising:
a gas line configured to receive a gas;
a heat exchanger connected to the gas line and comprising a gas valve for restricting flow of the gas and an ignition configured to selectively ignite the gas;
a fan configured to induce airflow across the heat exchanger at a first fan setting;
a pressure transducer configured to generate a transducer signal indicative of a first pressure value at the heat exchanger;
a first pressure switch configured to generate a first switch signal indicative of a second pressure value at the heat exchanger;
a controller configured to receive the transducer signal and the first switch signal,
wherein the controller is configured to compare the transducer signal to the first switch signal when the fan is at the first fan setting to determine that the pressure transducer is calibrated at the first fan setting.

2. The furnace system of claim 1, wherein the controller is configured to determine that the pressure transducer is calibrated when the first pressure value is the same as the second pressure value.

3. The furnace system of claim 1, further comprising a second pressure switch configured to generate a second switch signal indicative of a third pressure value.

4. The furnace system of claim 3, wherein the first pressure value corresponds to a first fuel-to-air mixture value of the furnace and the third pressure value corresponds to a second fuel-to-air mixture value of the furnace different than the first pressure value.

5. The furnace system of claim 3, wherein the second pressure value corresponds to a minimum operational pressure for the heat exchanger and the third pressure value corresponds to a maximum operational pressure for the heat exchanger.

6. The furnace system of claim 3, wherein the fan is configured to operate at a second fan setting and wherein the controller is further configured to receive the second switch value when the fan is at the second fan setting and compare the transducer signal to the second switch signal to determine the pressure transducer is calibrated at the second fan setting.

7. The furnace system of claim 1, wherein the controller is configured to cause the gas valve to open a set amount such that a first air-to-gas ratio is achieved when the fan is operated at the first setting.

8. The furnace system of claim 1, wherein the controller is configured to at least partially open the gas valve when the first pressure value is the same as the second pressure value.

9. The furnace system of claim 1, wherein the first pressure switch comprises a first inlet and the pressure transducer comprises a second inlet and the first inlet and the second inlet are each in fluid communication with a third inlet.

10. The furnace system of claim 1, wherein the pressure transducer is configured to wirelessly communicate the transducer signal to the controller.

11. A method for calibrating a gas furnace system, the method comprising:
causing, by a controller, a fan of the furnace system to operate at a first fan setting to generate a first airflow, the furnace system comprising the fan, a heat exchanger having a gas valve connected to a gas line for restricting a flow of gas, a pressure transducer, and a first pressure switch, the first airflow directed across the heat exchanger;
determining a transducer signal generated by the pressure transducer and indicative of a first pressure value at the heat exchanger at the first fan setting and corresponding to the first airflow;
determining a first switch signal generated by the first pressure switch indicative of a second pressure value at the heat exchanger at the first fan setting and corresponding to the first airflow;
determining that the first pressure value is the same as the second pressure value; and
determining that the pressure transducer is calibrated at the first fan setting based on the first pressure value being the same as the second pressure value.

12. The method of claim 11, further comprising, after determining the pressure transducer is calibrated at the first fan setting, causing the gas valve to open a set amount.

13. The method of claim 11, further comprising:
causing the fan to operate at a second fan setting to generate a second airflow across the heat exchanger;
determining a second transducer signal generated by the pressure transducer and indicative of a third pressure value at the heat exchanger at the second fan setting and corresponding to second airflow;
determining a second switch signal generated by a second pressure switch of the furnace system and indicative of a fourth pressure value at the heat exchanger at the second fan setting and corresponding to second airflow; and
determining that the third pressure value is the same as the fourth pressure value.

14. The method of claim 13, further comprising determining that the pressure transducer is calibrated at the second fan setting based on the third pressure value being the same as the fourth pressure value.

15. The method of claim 14, further comprising causing, after determining the pressure transducer is calibrated at the second fan setting, the gas valve to open a second amount and the fan to operate at the second fan setting.

16. The method of claim 15, wherein the second airflow is greater than the first airflow and the second amount is greater than the first amount.

17. The method of claim 13, wherein the second pressure value corresponds to a minimum operational pressure for the heat exchanger and the fourth pressure value corresponds to a maximum operational pressure for the heat exchanger.

18. The method of claim 11, wherein the first pressure switch comprises a first inlet and the pressure transducer comprises a second inlet and the first inlet and the second inlet are in fluid communication with a third inlet.

19. The method of claim 11, further comprising determining to calibrate the pressure transducer after a set period of time.

20. The method of claim 11, further comprising receiving, wirelessly, the transducer signal from the pressure transducer.
